(19) United States
(12) Patent Application Publication
(10) Pub. No.: US 2026/0348032 A1
(43) Pub. Date: Nov. 5, 2026

(54) Ti-RuO2 acidic oxygen evolution catalyst based on strain modulation strategy and preparation method thereof

(71) Applicant: CHINA UNIVERSITY OF PETROLEUM(EAST CHINA), Qingdao (CN)

(72) Inventors: Yichao Huang, Qingdao (CN); Ruili Gao, Qingdao (CN)

(21) Appl. No.: 19/388,156

(22) Filed: Nov. 13, 2025

(30) Foreign Application Priority Data
Apr. 30, 2025 (CN) 202510565013.1

(51) Int. Cl. C25B 11/093; C25B 1/04

(52) U.S. Cl. CPC C25B 11/093; C25B 1/04

(57) ABSTRACT

Ti-RuO2 acidic oxygen evolution catalyst based on strain modulation strategy and preparation method thereof, the preparation method comprises the following steps: S1. mixing TiO₂ with an acidic solution, and adjusting a pH value of the solution, and then performing dispersion to obtain a TiO₂ dispersion solution; S2. adding a soluble Ru salt into the TiO₂ dispersion solution under ice bath conditions, and stirring to obtain a mixed solution; S3. mixing the mixed solution with an alkaline solution, stirring the mixture, adjusting a pH value of the mixture, and then freeze-drying the mixture to obtain a precursor; and S4. pyrolyzing the precursor immediately at a high temperature, and then taking out the precursor promptly, and cooling the precursor to obtain a s-Ti-RuO₂ acidic oxygen evolution catalyst based on a strain modulation strategy. The mass activity of the catalyst obtained herein at 1.53 V is 6 times that of commercial RuO₂.

### TECHNICAL FIELD

This application relates to the technical field of hydrogen production catalysts, and in particular, to an s-Ti-RuO₂ acidic oxygen evolution catalyst based on a strain modulation strategy and a preparation method thereof.

### BACKGROUND

In water electrolysis for hydrogen production, proton exchange membrane (PEM) water electrolysis for hydrogen production is considered the most promising hydrogen production technology by virtue of advantages such as fast start-stop response and high current density. Water electrolysis involves hydrogen evolution reaction (HER) at the cathode and oxygen evolution reaction (OER) at the anode. The OER is a four-electron reaction process with inherently sluggish reaction kinetics. In acidic (with pH being 2 to 3) and highly oxidative (approximately 2.0 V) environments, almost all non-precious metals are corroded. Currently, the OER catalysts are primarily precious metals such as iridium (Ir) and ruthenium (Ru). IrO₂ is of the highest stability, and is used as an anode catalyst in PEM water electrolysis. However, IrO₂ is of poor activity and is expensive. RuO₂ is of high activity but poor stability.

Patent CN110820005A discloses a method for preparing an efficient and stable Ru-based acidic oxygen evolution electrocatalyst. The catalyst is prepared by impregnation, in which RuCl₃ is applied as a Ru source onto a carrier and then subjected to one-step heat treatment. The overpotential of the catalyst at a current density of 10 mA·cm⁻² is 260 mV, and the stability duration of the catalyst is as short as 111 h. Patent CN118558340A discloses a F-doped RuO₂ catalyst, a preparation method thereof, and the application of the catalyst to PEM water electrolysis. The overpotential of the catalyst at a current density of 10 mA·cm⁻² is 206 mV, and the stability duration of the catalyst is 500 h. CN118308751A discloses a Ru-based acidic oxygen evolution catalyst, and a preparation method and a use thereof, in which Mn, Ce-doped RuO₂ is prepared, and the overpotential of the catalyst at a current density of 10 mA·cm⁻² is 218 mV, and the stability duration of the catalyst is as short as 60 h.

Most of the catalysts mentioned above adopt a single regulation strategy, and are obviously insufficient in improving catalyst stability.

### SUMMARY

In view of the above situation, an objective of this application is to provide a s-Ti-RuO₂ acidic oxygen evolution catalyst based on a strain modulation strategy, and a preparation method thereof. The stability of the catalyst prepared herein is relatively high, the preparation method is simple, and the raw materials are easily available.

To achieve the above objective, this application puts forward the following technical solutions:

This application provides a method for preparing a s-Ti-RuO₂ acidic oxygen evolution catalyst based on a strain modulation strategy. The method includes the following steps:
S1. mixing TiO₂ with an acidic solution, and adjusting a pH value of the solution, and then performing dispersion to obtain a TiO₂ dispersion solution;
S2. adding a soluble Ru salt into the TiO₂ dispersion solution under ice bath conditions, and stirring to obtain a mixed solution;
S3. mixing the mixed solution with an alkaline solution, stirring the mixture, adjusting a pH value of the mixture, and then freeze-drying the mixture to obtain a precursor; and
S4. pyrolyzing the precursor immediately at a high temperature, and then taking out the precursor promptly, and cooling the precursor to obtain an s-Ti-RuO₂ acidic oxygen evolution catalyst based on a strain modulation strategy.

It is found herein that the instability of ruthenium-based catalysts is due to the strong binding energy between Ru and O at a high oxidation potential. The strong binding energy induces participation of lattice oxygen, leads to the formation of oxygen vacancies, and accelerates the dissolution and structural disruption of active Ru. Atomic doping is the most common regulation strategy, but the ability of a single regulation strategy to regulate the RuO₂ catalyst is limited. This application uses an acid-leaching-induced counter-doping process and a rapid quenching process to prepare an s-Ti-RuO₂ catalyst with atomic doping and tensile strain. Electrons are transferred from a Ti atom to an adjacent Ru site through bridging oxygen atoms. The tensile strain weakens the Ru—O covalency, places Ru in a low-valence state, and inhibits Ru dissolution and the participation of lattice oxygen.

Preferably, a concentration of the TiO₂ in the TiO₂ dispersion solution in step S1 is 1 to 10 mmol·L⁻¹.

Preferably, the acidic solution in step S1 is one of a HCl solution, a H₂SO₄ solution, a HNO₃ solution, or an HF solution.

Preferably, the pH value in step S1 is 2 to 3.

Preferably, the dispersion in step S1 is ultrasonic dispersion, with an ultrasonic power of 600 W and an ultrasonic time of 10 to 40 min.

Preferably, a molar ratio of the TiO₂ to the soluble Ru salt in the mixed solution in step S2 is (0.1 to 1):1.

Preferably, the soluble Ru salt is ruthenium trichloride or ruthenium nitrate.

Preferably, the stirring time in step S2 is 4 h.

Preferably, the pH value in step S3 is 6; and the alkaline solution is aqueous ammonia or sodium hydroxide.

Preferably, the stirring time in step S3 is 12 h.

Preferably, in step S4, the pyrolysis temperature is 250 °C to 550 °C, and the heating time is 1 to 3 h.

Preferably, the pyrolysis in step S4 is performed using a tube furnace.

Preferably, the cooling in step S4 may be natural cooling or liquid nitrogen cooling.

This application provides an s-Ti-RuO₂ acidic oxygen evolution catalyst based on a strain modulation strategy. The catalyst is obtained using the above preparation method.

The technical solutions of this application achieve at least the following beneficial technical effects:

This application achieves atomic-level doping of Ti into RuO₂ by an acid-leaching method. On the one hand, this improves the acid resistance and corrosion resistance of the catalyst under acidic conditions. On the other hand, this modulates the electronic structure of the RuO₂ to optimize the adsorption strength of the oxygen-containing intermediate, thereby enhancing catalytic activity. The catalyst exhibits an overpotential of 245 mV at a current density of 10 mA·cm⁻². The turnover frequency of s-Ti-RuO₂ is 8.8 times that of commercial RuO₂, and the mass activity thereof at 1.53 V is 6 times that of commercial RuO₂.

This application introduces lattice strain by using rapid quenching, thereby weakening the Ru—O covalency, suppressing the participation of the lattice oxygen, and improving the stability of RuO₂. The catalyst exhibits a stability duration of 830 h at a current density of 10 mA·cm⁻².

A PEM water electrolyzer is assembled by employing s-Ti-RuO₂ as an anode catalyst and employing a commercial Pt/C as a cathode catalyst. Polarization curves show that the Embodiment 1-based PEM water electrolyzer requires 1.609 V, 1.706 V and 1.796 V to achieve current densities of 1 A·cm⁻², 2 A·cm⁻², and 3 A·cm⁻², respectively, surpassing the U.S. DOE's 2026 target (3 A·cm⁻²@1.8 V). The PEM water electrolyzer remains stable for over 400 hours with a voltage degradation rate as low as 7.5 μV·h⁻¹ at a current density of 1 A·cm⁻².

### BRIEF DESCRIPTION OF DRAWINGS

FIG. 1 is an X-ray diffraction (XRD) pattern of a catalyst according to Embodiment 1 and Comparative Embodiment 2;

FIG. 2 is a scanning electron microscope (SEM) image of a catalyst according to Embodiment 1;

FIG. 3 is a scanning electron microscope (SEM) image of a catalyst according to Comparative Embodiment 2;

FIG. 4 is a scanning electron microscope (SEM) image of a catalyst according to Comparative Embodiment 3;

FIG. 5 is a transmission electron microscope (TEM) image and an element distribution chart of a catalyst according to Embodiment 1;

FIG. 6 is a spherical aberration-corrected transmission electron microscope (AC-TEM) image and a (110) plane intensity map of a catalyst according to Embodiment 1;

FIG. 7 is an X-ray photoelectron spectroscopy (XPS) spectrum of a catalyst according to Embodiment 1 and Comparative Embodiment 2;

FIG. 8 shows an acidic oxygen evolution reaction (OER) catalytic performance of a catalysts according to Embodiment 1, Comparative Embodiments 1 to 3 and commercial RuO₂ (c-RuO₂), measured in a three-electrode system using a linear sweep voltammetry (LSV);

FIG. 9 is a chronopotentiometric curve of a catalyst at a current density of 10 mA·cm⁻² according to Embodiment 1 and c-RuO₂;

FIG. 10 displays polarization curves of a PEM water electrolyzer with Embodiment 1 and c-RuO₂ as anode catalysts at 60 °C where electrolytic cell voltages are obtained without iR compensation;

FIG. 11 shows a chronopotentiometry curve of a PEM water electrolyzer with a catalyst in Embodiment 1 as tested at 60 °C at a current density of 1 A·cm⁻².

### DETAILED DESCRIPTION

Various exemplary embodiments of this application will be described in detail. The detailed description is to be considered not as a limitation on this application, but as a more detailed description of specified aspects, features, and implementation solutions of this application.

Understandably, the terms described herein are intended merely to describe particular embodiments but are not intended to limit this application. In addition, a numerical range herein is understood such that each intermediate value between the upper limit and the lower limit of the range is also specifically disclosed. Each smaller range between any stated value or any intermediate value within a stated range and any other stated value or intermediate value within the stated range is also encompassed by this application. The upper limit and the lower limit of the smaller range may be independently included in or excluded from the range.

Unless otherwise specified, all technical and scientific terms used herein have the same meanings as what is commonly understood by a person of ordinary skill in the art. Although merely preferred methods and materials are described herein, any methods and materials similar or equivalent to those described herein may also be used in the implementation or testing of this application. All documents cited in this specification are incorporated herein by reference to disclose and describe the methods and/or materials related to the documents. In the event of any conflict with the incorporated documents, the content hereof shall prevail.

Various improvements and variations may be made to the specific embodiments of this application without departing from the scope or spirit of this application, which is apparent to those skilled in the art. Other embodiments derived from this application are apparent to those skilled in the art. The specification and embodiments of this application are merely exemplary.

The words “include”, “comprise”, “have”, “contain”, and the like used herein are open-ended terms, and bear the meaning of “including but not limited to”.

Unless otherwise specified, the terms “room temperature” and “normal temperature” used herein are 25±2 °C.

Unless otherwise specified, all raw materials and instruments used in the following embodiments of this application are commercially available.

Preparation of TiO₂: Adding 10 mL of isopropanol into 5 mL of tetrabutyl titanate solution, stirring for 12 hours, and then adding deionized water in 5 increments under ultrasonication conditions, each increment being 100 mL. Drying the mixture in a blast air oven at 80 °C to obtain a white TiO₂ powder, ready for use in embodiments; or using a liquid organic titanium salt containing at least one of titanium tetramethoxide, tetrabutyl titanate, titanium isopropoxide, or titanium isooctoxide; or using commercially available TiO₂ powder.

### Embodiment 1

(1) Dissolving 0.1 mmol of TiO₂ in 100 mL of deionized water solution containing 0.1 mol·L⁻¹ HCl, adjusting the pH value to 2, and sonicating the solution for 30 min until complete dissolution.
(2) Subsequently, adding 0.9 mmol of RuCl₃ into the above solution under ice bath conditions. Stirring for 4 h, and then removing the ice bath, adding 0.3 wt % aqueous ammonia, adjusting the pH value to 6, and stirring for 12 h. Freezing the solution in a freezer for 12 h, and then freeze-drying the resulting product to obtain a precursor.
(3) Ventilating the tube furnace at both ends, and heating to 450 °C at a rate of 5 °C·min⁻¹. Placing the precursor into a porcelain boat, and quickly pushing the precursor into the heating zone to heat the precursor for 2 hours, and then pushing the precursor promptly into the cooling zone to cool the precursor naturally to obtain a Ti-doped RuO₂ catalyst with tensile strain, named s-Ti-RuO₂.

### embodiment 2

(1) Dissolving 0.5 mmol of TiO₂ in 100 mL of deionized water solution containing 0.1 mol·L⁻¹ H₂SO₄, adjusting the pH value to 2.5, and sonicating the solution for 30 min until complete dissolution.
(2) Subsequently, adding 0.5 mmol of ruthenium nitrate into the above solution under ice bath conditions. Stirring for 4 h, and then removing the ice bath, adding 0.3 wt % aqueous ammonia, adjusting the pH value to 6, and stirring for 12 h. Freezing the solution in a freezer for 12 h, and then freeze-drying the resulting product to obtain a precursor.
(3) Ventilating the tube furnace at both ends, and heating to 250 °C at a rate of 5 °C·min⁻¹. Placing the precursor into a porcelain boat, and quickly pushing the precursor into the heating zone to heat the precursor for 3 hours, and then pushing the precursor promptly into the cooling zone to cool the precursor with liquid nitrogen to obtain a Ti-doped RuO₂ catalyst with tensile strain, named s-Ti-RuO₂.

### Embodiment 3

(1) Dissolving 1 mmol of TiO₂ in 100 mL of deionized water solution containing 0.1 mol·L⁻¹ HCl, adjusting the pH value to 3, and sonicating the solution for 30 min until complete dissolution.
(2) Subsequently, adding 5 mmol of RuCl₃ into the above solution under ice bath conditions. Stirring for 4 h, and then removing the ice bath, adding 0.3 wt % sodium hydroxide, adjusting the pH value to 6, and stirring for 12 h. Freezing the solution in a freezer for 12 h, and then freeze-drying the resulting product to obtain a precursor.
(3) Ventilating the tube furnace at both ends, and heating to 550 °C at a rate of 5 °C·min⁻¹. Placing the precursor into a porcelain boat, and quickly pushing the precursor into the heating zone to heat the precursor for 1 hour, and then pushing the precursor promptly into the cooling zone to cool the precursor naturally at room temperature to obtain a Ti-doped RuO₂ catalyst with tensile strain, named s-Ti-RuO₂.

### Comparative Embodiment 1

The preparation method of this comparative embodiment is the same as that of Embodiment 1 except that TiO₂ is replaced by TiCl₄ and the resulting catalyst is named s-Ti-RuO₂-2.

### Comparative Embodiment 2

The preparation method of this comparative embodiment is the same as that of Embodiment 1 except that in step (3), the precursor is placed in a porcelain boat, and the temperature is raised to 450 °C at a rate of 5 °C·min⁻¹ under conditions of ventilation at both ends of a tube furnace, and this temperature is kept for 2 h to obtain a Ti-doped RuO₂ catalyst, named Ti-RuO₂.

In this comparative embodiment, the precursor is gradually heated to 450 °C instead of being directly placed in a 450 °C environment.

### Comparative Embodiment 3

The preparation method of this comparative embodiment is the same as that of Embodiment 1 except that step (1) is performed without adding TiO₂ and the resulting catalyst is named s-RuO₂.

### Experimental Example

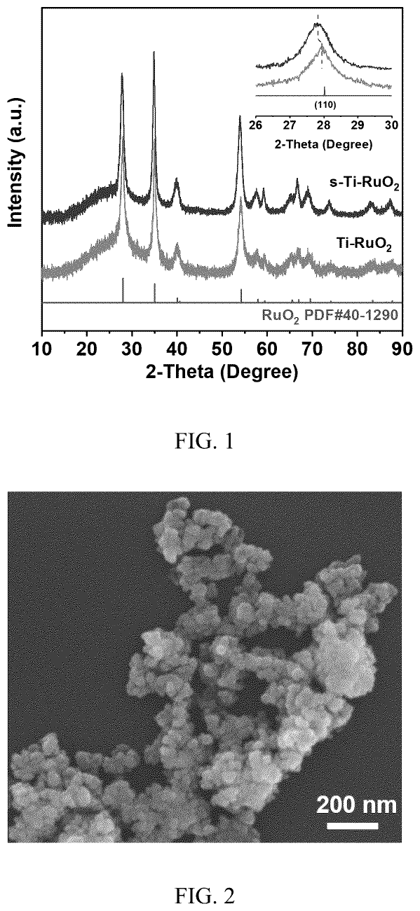

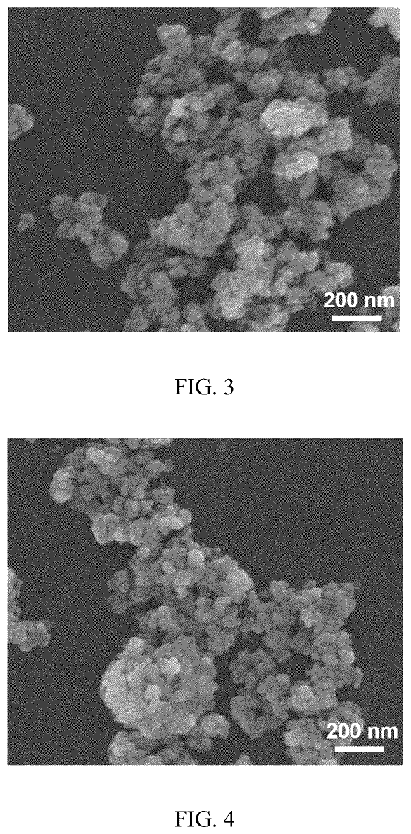

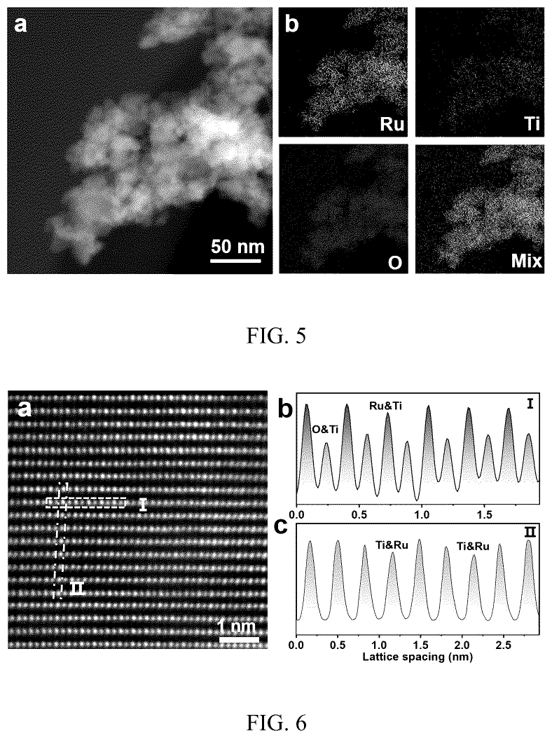

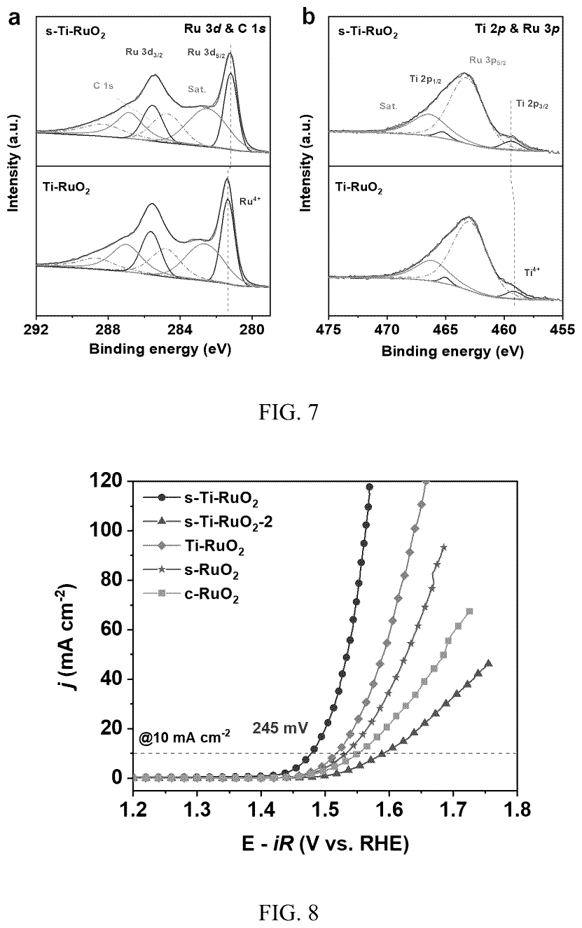

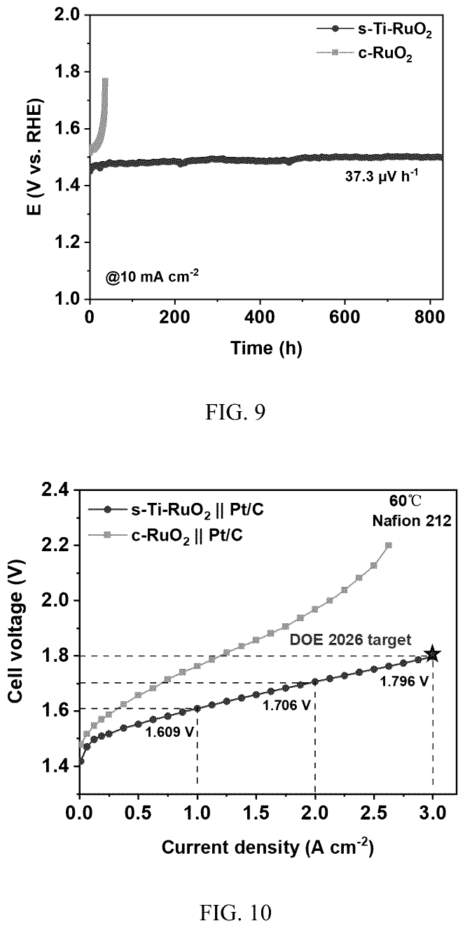

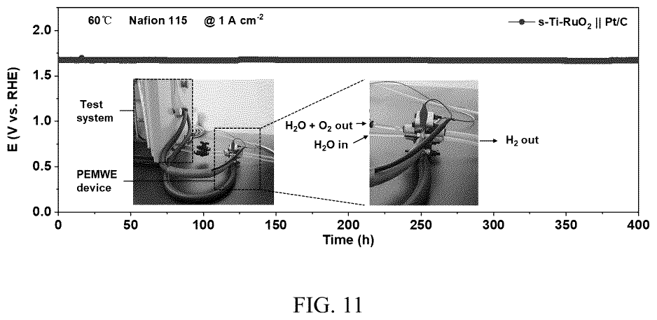

1. FIG. 1 to FIG. 7 show that, by using the method disclosed herein, an s-Ti-RuO₂ catalyst with atomic doping and tensile strain is prepared, and Ti is distributed evenly throughout the material. Compared to Ti-RuO₂, in the s-Ti-RuO₂ with strain, Ru 3d shifts toward low binding energy, and Ti 2p shifts toward high binding energy, indicating electron transfer from the Ti site to the Ru site through bridging oxygen (Ru gains electrons, resulting in a decrease in valence). The presence of strain regulates the generation of low-valent Ru, inhibits the dissolution of high-valent Ru in s-Ti-RuO₂ during acidic OER, and improves OER durability.
2. Dispersing 5 mg of catalyst obtained in Embodiment 1 and each comparative embodiment in 495 μL of water, 495 μL of isopropanol, and 10 μL of Nafion solution, separately. Ultrasonically dispersing the catalyst in the solution, ready for future use, and then applying 10 μL of the solution dropwise onto a 5 mm glassy carbon electrode, and using the glassy carbon electrode as a working electrode. Using reversible hydrogen as a reference electrode, and using a carbon rod as a counter electrode. Performing research on the electrocatalytic oxygen evolution performance in a 0.5 mol·L⁻¹ H₂SO₄ solution. The catalytic performance of the acidic oxygen evolution reaction is shown in FIG. 8. As can be seen, the catalytic performance of Embodiment 1 is significantly higher than that of the comparative embodiment.
3. Testing, at a current density of 10 mA·cm⁻², the stability of the electrode prepared from the catalyst of Embodiment 1 and c-RuO₂, as shown in FIG. 9. As can be seen, the catalyst of Embodiment 1 still remains relatively stable within 830 hours, c-RuO₂ shows a rapid degradation to more than 1.8 V within 36 hours.
4. A PEM water electrolyzer is assembled by employing the anode catalyst in Embodiment 1 and employing commercial Pt/C as a cathode catalyst to evaluate the industrial application potential. Polarization curves show that the PEM water electrolyzer in Embodiment 1 requires 1.609 V, 1.706 V and 1.796 V to achieve current densities of 1, 2, and 3 A·cm⁻², respectively, surpassing the U.S. DOE's 2026 target (3 A·cm⁻²@1.8 V) (FIG. 10).
5. The PEM water electrolyzer remains stable for over 400 hours with a voltage degradation rate as low as 7.5 μV·h⁻¹ at a current density of 1 A·cm⁻², as shown in FIG. 11.

The foregoing descriptions are merely exemplary embodiments of this application. It should be noted that various improvements and modifications made by persons of ordinary skill in the art within the principle of this application shall fall within the protection scope of this application.

What is claimed is:

1. A method for preparing an s-Ti-RuO₂ acidic oxygen evolution catalyst based on a strain modulation strategy, wherein the method comprises the following steps:
S1. mixing TiO₂ with an acidic solution, and adjusting a pH value of the solution, and then performing dispersion to obtain a TiO₂ dispersion solution;
S2. adding a soluble Ru salt into the TiO₂ dispersion solution under ice bath conditions, and stirring to obtain a mixed solution;
S3. mixing the mixed solution with an alkaline solution, stirring the mixture, adjusting a pH value of the mixture, and then freeze-drying the mixture to obtain a precursor; and
S4. After the temperature of the tubular furnace is raised to a predetermined heating temperature, the precursor is placed in a porcelain boat and quickly pushed into the heating zone, so that the precursor is immediately subjected to high-temperature pyrolysis at the heating temperature, and then taking out the precursor promptly, and cooling the precursor to obtain an s-Ti-RuO₂ acidic oxygen evolution catalyst based on a strain modulation strategy.

2. The preparation method according to claim 1, wherein a concentration of the TiO₂ in the TiO₂ dispersion solution in step S1 is 1 to 10 mmol·L⁻¹.

3. The preparation method according to claim 1, wherein the acidic solution in step S1 is one of a HCl solution, a H₂SO₄ solution, a HNO₃ solution, or an HF solution.

4. The preparation method according to claim 1, wherein the pH value in step S1 is 2 to 3.

5. The preparation method according to claim 1, wherein the dispersion in step S1 is ultrasonic dispersion, with an ultrasonic power of 600 W and an ultrasonic time of 10 to 40 min.

6. The preparation method according to claim 1, wherein a molar ratio of the TiO₂ to the soluble Ru salt in the mixed solution in step S2 is (0.1 to 1):1.

7. The preparation method according to claim 1, wherein the pH value in step S3 is 6.

8. The preparation method according to claim 1, wherein the alkaline solution in step S3 is aqueous ammonia or sodium hydroxide.

9. The preparation method according to claim 1, wherein in step S4, the pyrolysis temperature is 250 °C to 550 °C, and the heating time is 1 to 3 h.

10. (canceled)
